(19) United States
(12) Patent Application Publication
(10) Pub. No.: US 2026/0187910 A1
(43) Pub. Date: Jul. 2, 2026

(54) SYSTEMS AND METHODS FOR PROVIDING INTERACTIVITY WITH LIGHT SOURCES IN A SCENE DESCRIPTION

(71) Applicant: InterDigital CE Patent Holdings, SAS, Paris (FR)

(72) Inventors: Etienne Faivre d'Arcier, Saint Gonlay (FR); Pierrick Jouet, Rennes (FR); Loic Fontaine, Noyal sur Vilaine (FR); Patrice Hirtzlin, Betton (FR); Sylvain Lelievre, Montgermont (FR)

(21) Appl. No.: 18/867,755

(22) PCT Filed: Jun. 7, 2023
(86) PCT No.: PCT/EP2023/065281

§ 371 Date: Nov. 20, 2024

(30) Foreign Application Priority Data
Jun. 16, 2022 (EP) 22305880.1

(51) Int. Cl. G06T 15/50; G06T 19/20

(52) U.S. Cl. CPC G06T 15/506; G06T 19/20; G06T 2219/2012

(57) ABSTRACT

Scene description data is obtained for a 3D scene. The scene description data includes: scene element information describing each of a plurality of scene elements in the scene, trigger information describing at least one trigger condition, action information describing at least one action to perform on one or more scene elements associated with the action, and behavior information, where the behavior information associates at least one of the trigger conditions with at least one of the actions. If at least one of the trigger conditions has been met and an action is associated with the trigger conditions by the behavior information, the action is performed on at least one scene element associated with the action. In some embodiments, at least one of the scene elements is a virtual light source and at least one of the actions is an action performed on the virtual light source, such as changing the intensity, color, or size of the virtual light source.

### CROSS-REFERENCE TO RELATED APPLICATIONS

This application claims priority of European Patent Application No. EP22305880.1, filed 16 Jun. 2022, which is incorporated herein by reference in its entirety.

### BACKGROUND

Various technologies are available for generating, processing, and rendering virtual three-dimensional (3D) scenes. The information characterizing a 3D scene, referred to as a scene description, can be time-dependent, allowing a 3D scene to change in a manner analogous to playback of a video. This kind of behavior can be achieved by relying on the framework defined in the Scene Description for MPEG media document, Information technology—Coded representation of immersive media—Part14: Scene Description for MPEG media, ISO/IEC DIS 23090-14:2021 (E). A scene update mechanism based on the JSON Patch protocol as defined in IETF RFC 6902 may be used to synchronize virtual content to MPEG media streams.

Although the MPEG-I Scene Description framework ensures that the timed media and the corresponding relevant virtual content are available at any time, it does not provide a description of how a user can interact with the scene objects at runtime for immersive XR experiences. Hence, it does not provide support for user specific XR experiences based on the immersive media.

### SUMMARY

A method according to some embodiments comprises obtaining scene description data for a 3D scene. The scene description data includes: scene element information describing each of a plurality of scene elements in the scene, trigger information describing at least one trigger condition, action information describing at least one action to perform on one or more scene elements associated with the action, and behavior information, wherein the behavior information associates at least one of the trigger conditions with at least one of the actions. In response to a determination that at least one of the trigger conditions has been met and that at least a first one of the actions is associated with the trigger conditions by the behavior information, the first action is performed on at least a first scene element associated with the first action. In some embodiments, at least one of the scene elements is a virtual light source and at least one of the actions is an action performed on the virtual light source.

Actions that may be performed on a virtual light source according to some embodiments include one or more of the following: multiplying an intensity of the virtual light source by a specified value; setting a value indicating whether or not shadows are cast by the virtual light source; changing a color of the virtual light source; setting a distance cutoff for the virtual light source; defining an inner cone angle where intensity falloff begins for a virtual spot light; defining an outer cone angle where intensity falloff ends for a virtual spot light; changing a width of a virtual area light source; changing a height of a virtual area light source; applying a specified rotation to a virtual cubemap light source; applying a multiplier to irradiance coefficients of a virtual cubemap light source; changing resolution of images of the virtual cubemap light source; defining images to be used by the virtual cubemap light source.

In some embodiments, at trigger condition may be satisfied under one or more of the following conditions: a visibility condition that is satisfied when a specified node in the scene description is visible to a specified camera node; a proximity condition that is satisfied when a distance from a reference node (for instance a user camera) to a specified node is within specified bounds; a user input condition that is satisfied when a specified user interaction is detected; timed condition that is satisfied during a specified time period; a collider condition that is satisfied in response to detection of a collision between specified nodes.

In some embodiments, the behavior information identifies at least one behavior, the behavior information for each behavior identifying at least one of the triggers and at least one of the actions. In some embodiments, the behavior information includes information indicating, for at least one behavior, whether the identified actions are to be performed in response to at least one of the identified triggers or whether the identified actions are to be performed only in response to all of the identified triggers. In some embodiments, the behavior information includes information indicating, for at least one behavior, an order in which the identified actions are to be performed. In some embodiments, the behavior information includes information indicating that the identified actions are to be performed concurrently.

Example embodiments further include an apparatus comprising one or more processors configured to perform any of the methods described herein.

Example embodiments further include a computer-readable medium including instructions for causing one or more processors to perform any of the methods described herein. The computer-readable medium may be a non-transitory storage medium.

Example embodiments further include a computer program product including instructions which, when the program is executed by one or more processors, causes the one or more processors to carry out any of the methods described herein.

A signal according to some embodiments comprises scene description data for a 3D scene. The scene description data includes scene element information describing each of a plurality of scene elements in the scene, trigger information describing at least one trigger condition, action information describing at least one action to perform on one or more scene elements associated with the action, and behavior information, wherein the behavior information associates at least one of the trigger conditions with at least one of the actions. In some embodiments, at least one of the scene elements is a virtual light source, and at least one of the actions is associated with the virtual light source.

A computer-readable medium according to some embodiments comprises scene description data for a 3D scene. The scene description data includes scene element information describing each of a plurality of scene elements in the scene, trigger information describing at least one trigger condition, action information describing at least one action to perform on one or more scene elements associated with the action, and behavior information, wherein the behavior information associates at least one of the trigger conditions with at least one of the actions. In some embodiments, at least one of the scene elements is a virtual light source, and at least one of the actions is associated with the virtual light source.

### BRIEF DESCRIPTION OF THE DRAWINGS

FIG. 1A is a cross-sectional schematic view of a waveguide display that may be used with extended reality applications according to some embodiments.

FIGS. 1B-1C are cross-sectional schematic views alternative display types that may be used with extended reality applications according to some embodiments.

FIG. 1D is a functional block diagram of a system used in some embodiments described herein.

FIG. 1E illustrates an example of relationship between a scene description (stored as item in glTF.json), three video tracks, an audio track and a JSON patch update track in an ISOBMFF file.

FIG. 2 illustrates an example of an MPEG-I node hierarchy supporting elements of scene interactivity according to some embodiments.

FIG. 3 is a flow diagram illustrating the operation of an “activate once” parameter according to some embodiments.

FIG. 4 is a flow diagram illustrating processing of interactive behavior in response to a change to the scene description.

FIG. 5 schematically illustrates an example of logical relationships between trigger information (describing triggers 1 through n), action information (describing actions 1 through m), and behavior information (describing relationships between the triggers and actions). Triggers and actions may refer to one or more nodes or other scene elements in a scene description such as a hierarchical scene graph.

FIG. 6 is a flow diagram illustrating a method performed in some embodiments.

### DETAILED DESCRIPTION

### Extended-Reality (XR) Display Devices.

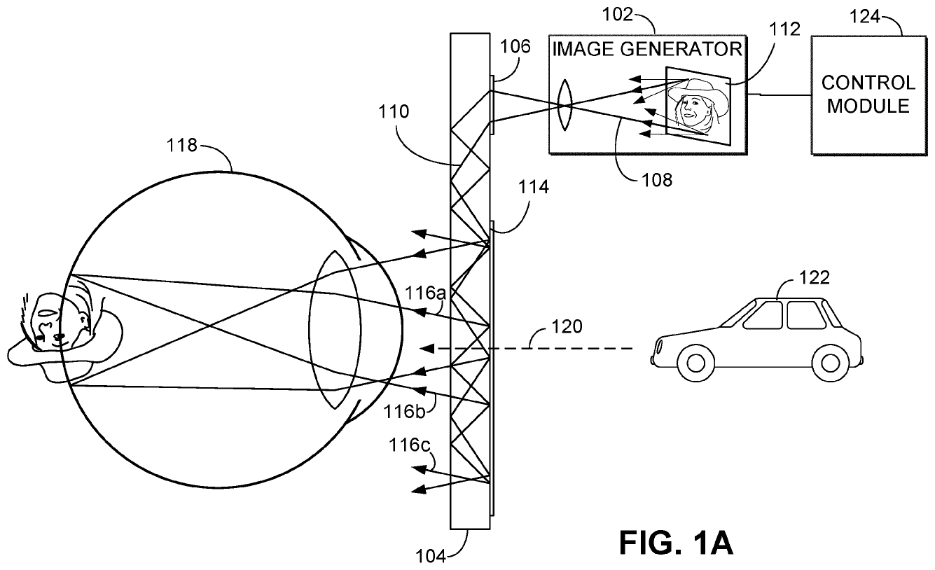

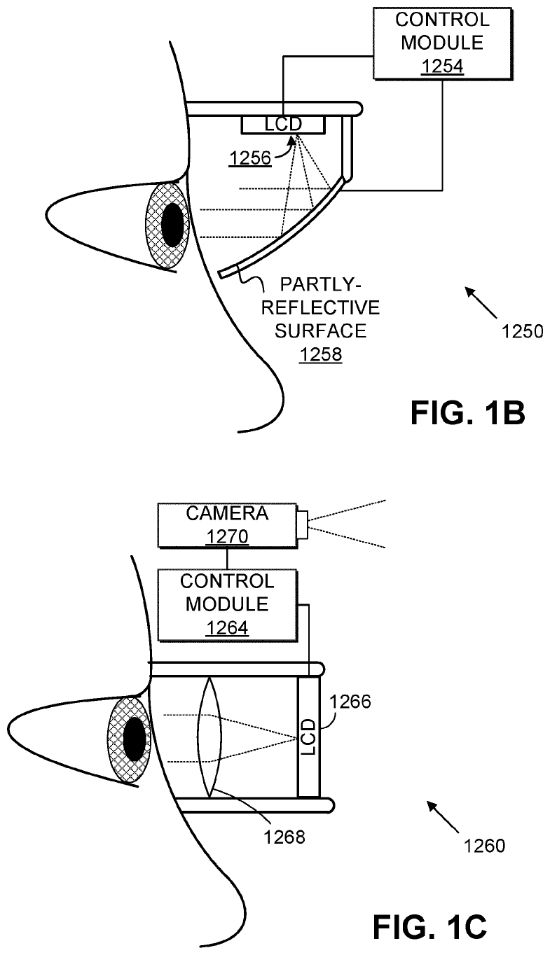

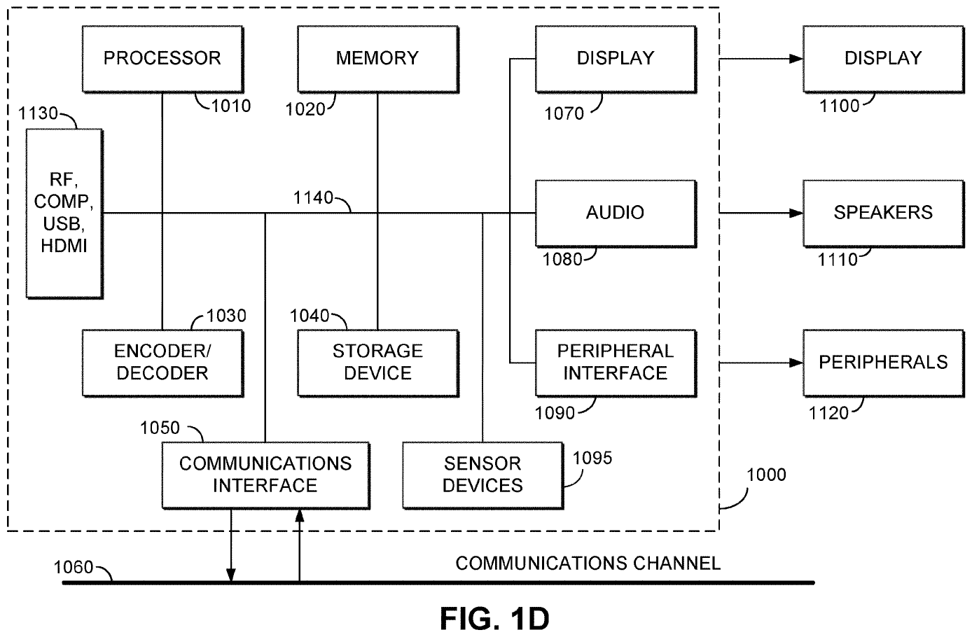

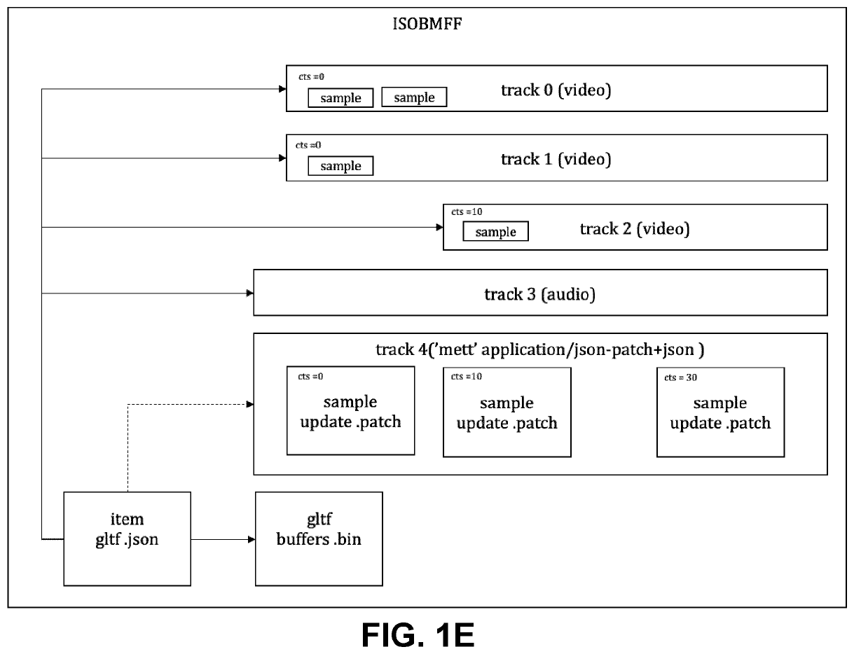

An example extended reality (XR) display device is illustrated in FIG. 1A. FIG. 1A is a schematic cross-sectional side view of a waveguide display device in operation. An image is projected by an image generator 102. The image generator 102 may use one or more of various techniques for projecting an image. For example, the image generator 102 may be a laser beam scanning (LBS) projector, a liquid crystal display (LCD), a light-emitting diode (LED) display (including an organic LED (OLED) or micro LED (μLED) display), a digital light processor (DLP), a liquid crystal on silicon (LCoS) display, or other type of image generator or light engine.

Light representing an image 112 generated by the image generator 102 is coupled into a waveguide 104 by a diffractive in-coupler 106. The in-coupler 106 diffracts the light representing the image 112 into one or more diffractive orders. For example, light ray 108, which is one of the light rays representing a portion of the bottom of the image, is diffracted by the in-coupler 106, and one of the diffracted orders 110 (e.g. the second order) is at an angle that is capable of being propagated through the waveguide 104 by total internal reflection. The image generator 102 displays images as directed by a control module 124, which operates to render image data, video data, point cloud data, or other displayable data.

At least a portion of the light 110 that has been coupled into the waveguide 104 by the diffractive in-coupler 106 is coupled out of the waveguide by a diffractive out-coupler 114. At least some of the light coupled out of the waveguide 104 replicates the incident angle of light coupled into the waveguide. For example, in the illustration, out-coupled light rays 116a, 116b, and 116c replicate the angle of the in-coupled light ray 108. Because light exiting the out-coupler replicates the directions of light that entered the in-coupler, the waveguide substantially replicates the original image 112. A user's eye 118 can focus on the replicated image.

In the example of FIG. 1A, the out-coupler 114 out-couples only a portion of the light with each reflection allowing a single input beam (such as beam 108) to generate multiple parallel output beams (such as beams 116a, 116b, and 116c). In this way, at least some of the light originating from each portion of the image is likely to reach the user's eye even if the eye is not perfectly aligned with the center of the out-coupler. For example, if the eye 118 were to move downward, beam 116c may enter the eye even if beams 116a and 116b do not, so the user can still perceive the bottom of the image 112 despite the shift in position. The out-coupler 114 thus operates in part as an exit pupil expander in the vertical direction. The waveguide may also include one or more additional exit pupil expanders (not shown in FIG. 1A) to expand the exit pupil in the horizontal direction.

In some embodiments, the waveguide 104 is at least partly transparent with respect to light originating outside the waveguide display. For example, at least some of the light 120 from real-world objects (such as object 122) traverses the waveguide 104, allowing the user to see the real-world objects while using the waveguide display. As light 120 from real-world objects also goes through the diffraction grating 114, there will be multiple diffraction orders and hence multiple images. To minimize the visibility of multiple images, it is desirable for the diffraction order zero (no deviation by 114) to have a great diffraction efficiency for light 120 and order zero, while higher diffraction orders are lower in energy. Thus, in addition to expanding and out-coupling the virtual image, the out-coupler 114 is preferably configured to let through the zero order of the real image. In such embodiments, images displayed by the waveguide display may appear to be superimposed on the real world.

FIG. 1B schematically illustrates an alternative type of extended reality head-mounted display that may be used in some embodiments. In an XR head-mounted display device 1250, a control module 1254 controls a display 1256, which may be an LCD, to display an image. The head-mounted display includes a partly-reflective surface 1258 that reflects (and in some embodiments, both reflects and focuses) the image displayed on the LCD to make the image visible to the user. The partly-reflective surface 1258 also allows the passage of at least some exterior light, permitting the user to see their surroundings.

FIG. 1C schematically illustrates an alternative type of extended reality head-mounted display that may be used in some embodiments. In an XR head-mounted display device 1260, a control module 1264 controls a display 1266, which may be an LCD, to display an image. The image is focused by one or more lenses of display optics 1268 to make the image visible to the user. In the example of FIG. 1C, exterior light does not reach the user's eyes directly. However, in some such embodiments, an exterior camera 1270 may be used to capture images of the exterior environment and display such images on the display 1266 together with any virtual content that may also be displayed.

The embodiments described herein are not limited to any particular type or structure of XR display device.

An extended reality display device, together with its control electronics, may be implemented using a system such as the system of FIG. 1D. FIG. 1D is a block diagram of an example of a system in which various aspects and embodiments are implemented. System 1000 can be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 1000, singly or in combination, can be embodied in a single integrated circuit (IC), multiple ICs, and/or discrete components. For example, in at least one embodiment, the processing and encoder/decoder elements of system 1000 are distributed across multiple ICs and/or discrete components. In various embodiments, the system 1000 is communicatively coupled to one or more other systems, or other electronic devices, via, for example, a communications bus or through dedicated input and/or output ports. In various embodiments, the system 1000 is configured to implement one or more of the aspects described in this document.

The system 1000 includes at least one processor 1010 configured to execute instructions loaded therein for implementing, for example, the various aspects described in this document. Processor 1010 can include embedded memory, input output interface, and various other circuitries as known in the art. The system 1000 includes at least one memory 1020 (e.g., a volatile memory device, and/or a non-volatile memory device). System 1000 includes a storage device 1040, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 1040 can include an internal storage device, an attached storage device (including detachable and non-detachable storage devices), and/or a network accessible storage device, as non-limiting examples.

System 1000 includes an encoder/decoder module 1030 configured, for example, to process data to provide an encoded video or decoded video, and the encoder/decoder module 1030 can include its own processor and memory. The encoder/decoder module 1030 represents module(s) that can be included in a device to perform the encoding and/or decoding functions. As is known, a device can include one or both of the encoding and decoding modules. Additionally, encoder/decoder module 1030 can be implemented as a separate element of system 1000 or can be incorporated within processor 1010 as a combination of hardware and software as known to those skilled in the art.

Program code to be loaded onto processor 1010 or encoder/decoder 1030 to perform the various aspects described in this document can be stored in storage device 1040 and subsequently loaded onto memory 1020 for execution by processor 1010. In accordance with various embodiments, one or more of processor 1010, memory 1020, storage device 1040, and encoder/decoder module 1030 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 1010 and/or the encoder/decoder module 1030 is used to store instructions and to provide working memory for processing that is needed during encoding or decoding. In other embodiments, however, a memory external to the processing device (for example, the processing device can be either the processor 1010 or the encoder/decoder module 1030) is used for one or more of these functions. The external memory can be the memory 1020 and/or the storage device 1040, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 1000 can be provided through various input devices as indicated in block 1130. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1C, include composite video.

In various embodiments, the input devices of block 1130 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 1000 to other electronic devices across USB and/or HDMI connections. It is to be understood that various aspects of input processing, for example, Reed-Solomon error correction, can be implemented, for example, within a separate input processing IC or within processor 1010 as necessary. Similarly, aspects of USB or HDMI interface processing can be implemented within separate interface ICs or within processor 1010 as necessary. The demodulated, error corrected, and demultiplexed stream is provided to various processing elements, including, for example, processor 1010, and encoder/decoder 1030 operating in combination with the memory and storage elements to process the datastream as necessary for presentation on an output device.

Various elements of system 1000 can be provided within an integrated housing, Within the integrated housing, the various elements can be interconnected and transmit data therebetween using suitable connection arrangement 1140, for example, an internal bus as known in the art, including the Inter-IC (I2C) bus, wiring, and printed circuit boards.

The system 1000 includes communication interface 1050 that enables communication with other devices via communication channel 1060. The communication interface 1050 can include, but is not limited to, a transceiver configured to transmit and to receive data over communication channel 1060. The communication interface 1050 can include, but is not limited to, a modem or network card and the communication channel 1060 can be implemented, for example, within a wired and/or a wireless medium.

Data is streamed, or otherwise provided, to the system 1000, in various embodiments, using a wireless network such as a Wi-Fi network, for example IEEE 802.11 (IEEE refers to the Institute of Electrical and Electronics Engineers). The Wi-Fi signal of these embodiments is received over the communications channel 1060 and the communications interface 1050 which are adapted for Wi-Fi communications. The communications channel 1060 of these embodiments is typically connected to an access point or router that provides access to external networks including the Internet for allowing streaming applications and other over-the-top communications. Other embodiments provide streamed data to the system 1000 using a set-top box that delivers the data over the HDMI connection of the input block 1130. Still other embodiments provide streamed data to the system 1000 using the RF connection of the input block 1130. As indicated above, various embodiments provide data in a non-streaming manner. Additionally, various embodiments use wireless networks other than Wi-Fi, for example a cellular network or a Bluetooth network.

The system 1000 can provide an output signal to various output devices, including a display 1100, speakers 1110, and other peripheral devices 1120. The display 1100 of various embodiments includes one or more of, for example, a touchscreen display, an organic light-emitting diode (OLED) display, a curved display, and/or a foldable display. The display 1100 can be for a television, a tablet, a laptop, a cell phone (mobile phone), or other device. The display 1100 can also be integrated with other components (for example, as in a smart phone), or separate (for example, an external monitor for a laptop). The other peripheral devices 1120 include, in various examples of embodiments, one or more of a stand-alone digital video disc (or digital versatile disc) (DVR, for both terms), a disk player, a stereo system, and/or a lighting system. Various embodiments use one or more peripheral devices 1120 that provide a function based on the output of the system 1000. For example, a disk player performs the function of playing the output of the system 1000.

In various embodiments, control signals are communicated between the system 1000 and the display 1100, speakers 1110, or other peripheral devices 1120 using signaling such as AV.Link, Consumer Electronics Control (CEC), or other communications protocols that enable device-to-device control with or without user intervention. The output devices can be communicatively coupled to system 1000 via dedicated connections through respective interfaces 1070, 1080, and 1090. Alternatively, the output devices can be connected to system 1000 using the communications channel 1060 via the communications interface 1050. The display 1100 and speakers 1110 can be integrated in a single unit with the other components of system 1000 in an electronic device such as, for example, a television. In various embodiments, the display interface 1070 includes a display driver, such as, for example, a timing controller (T Con) chip.

The display 1100 and speaker 1110 can alternatively be separate from one or more of the other components, for example, if the RF portion of input 1130 is part of a separate set-top box. In various embodiments in which the display 1100 and speakers 1110 are external components, the output signal can be provided via dedicated output connections, including, for example, HDMI ports, USB ports, or COMP outputs.

The system 1000 may include one or more sensor devices 1095. Examples of sensor devices that may be used include one or more GPS sensors, gyroscopic sensors, accelerometers, light sensors, cameras, depth cameras, microphones, and/or magnetometers. Such sensors may be used to determine information such as user's position and orientation. Where the system 1000 is used as the control module for an extended reality display (such as control modules 124, 1254), the user's position and orientation may be used in determining how to render image data such that the user perceives the correct portion of a virtual object or virtual scene from the correct point of view. In the case of head-mounted display devices, the position and orientation of the device itself may be used to determine the position and orientation of the user for the purpose of rendering virtual content. In the case of other display devices, such as a phone, a tablet, a computer monitor, or a television, other inputs may be used to determine the position and orientation of the user for the purpose of rendering content. For example, a user may select and/or adjust a desired viewpoint and/or viewing direction with the use of a touch screen, keypad or keyboard, trackball, joystick, or other input. Where the display device has sensors such as accelerometers and/or gyroscopes, the viewpoint and orientation used for the purpose of rendering content may be selected and/or adjusted based on motion of the display device.

The embodiments can be carried out by computer software implemented by the processor 1010 or by hardware, or by a combination of hardware and software. As a non-limiting example, the embodiments can be implemented by one or more integrated circuits. The memory 1020 can be of any type appropriate to the technical environment and can be implemented using any appropriate data storage technology, such as optical memory devices, magnetic memory devices, semiconductor-based memory devices, fixed memory, and removable memory, as non-limiting examples. The processor 1010 can be of any type appropriate to the technical environment, and can encompass one or more of microprocessors, general purpose computers, special purpose computers, and processors based on a multi-core architecture, as non-limiting examples.

### Scene Description Framework for XR.

In XR applications, a scene description is used to combine explicit and easy-to-parse description of a scene structure and some binary representations of media content.

In time-based media streaming, the scene description itself can be time-evolving to provide the relevant virtual content for each sequence of a media stream. For instance, for advertising purpose, a virtual bottle can be displayed during a video sequence where people are drinking.

This kind of behavior can be achieved by relying on the framework defined in the Scene Description for MPEG media document, Information technology-Coded representation of immersive media-Part14: Scene Description for MPEG media, ISO/IEC DIS 23090-14:2021 (E). A scene update mechanism based on the JSON Patch protocol as defined in IETF RFC 6902 may be used to synchronize virtual content to MPEG media streams.

FIG. 1E illustrates an example of relationship between a scene description (stored as item in glTF.json), three video tracks, an audio track and a JSON patch update track in an ISOBMFF file.

Although the MPEG-I Scene Description framework ensures that the timed media and the corresponding relevant virtual content are available at any time, it does not provide a description of how a user can interact with the scene objects at runtime for immersive XR experiences. Hence, there is no support of user specific XR experiences for consuming the immersive media.

Example embodiments as described herein may be used to provide a scene description that includes a virtual object or light source but that does not necessarily display or render the virtual object or light source even if available. In some embodiments, one or more of the following aspects may be considered in determining whether to display a virtual object or light source.

A spatial aspect may be considered in determining whether to display a virtual object or light source. For example, if the user environment is not suited (e.g. the user is too far from the rendered timed media's location) or if the user is not looking toward the right direction, or if the virtual object should be displayed on a user-specific area (e.g. above his left hand which is not yet detected), then the virtual object or light source may not be displayed.

A temporal aspect may be considered in determining whether to display a virtual object or light source. For example, if the user is not yet ready or wants to trigger himself the display of the object (e.g. using a specific gesture), the virtual object or light source may not be displayed until the appropriate trigger is detected.

In some embodiments, it is specified in the scene description which objects or light sources the user is allowed to manipulate or to interact with through potential haptic feedbacks.

### Runtime Interactivity.

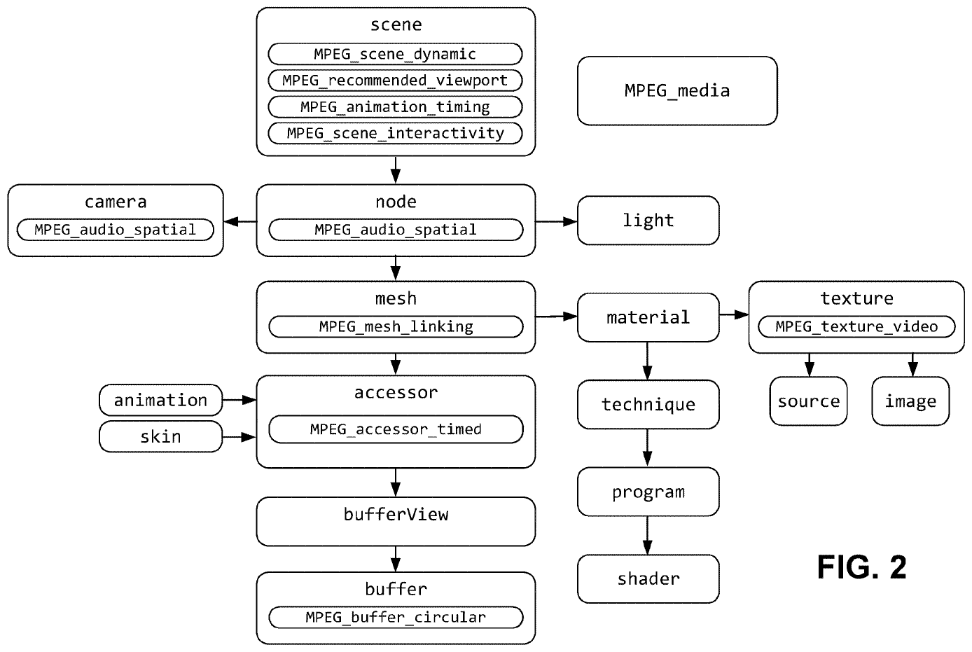

In example embodiments, the time-evolving scene description is augmented by adding information identifying behaviors. These behaviors may be related to pre-defined virtual objects on which runtime interactivity is allowed for user specific XR experiences. An example of an MPEG-I node hierarchy supporting elements of scene interactivity is illustrated in FIG. 2.

In some embodiments, these behaviors are time-evolving. In such embodiments, the behaviors may be updated through the already-existing scene description update mechanism.

In example embodiments, a behavior is characterized by one or more of the following properties:
One or more triggers defining the conditions to be met for activation.
A trigger control parameter defining the logical operations between the defined triggers.
Actions to be implemented in response to the activation of the triggers.
An action control parameter defining the order of execution of the defined actions.
A priority number enabling the selection of the behavior of highest priority in the case of concurrence of several behaviors on the same virtual object at the same time.
An optional interrupt action to specify how to terminate this behavior when the behavior is no longer defined in a newly received scene update. For instance, a behavior is no longer defined if the related object has been removed or if the behavior is no longer relevant for this current media (e.g. audio or video) sequence.

With the addition of these behaviors, the way a user can interact at runtime in an immersive content for XR experiences may be defined.

Example embodiments are described with reference to the scope of the MPEG-I Scene Description framework using the Khronos gITF extension mechanism, which supports additional scene description features. However, the principles described herein are not limited to a particular scene description framework.

In an example embodiment, the gITF scene description is extended to support interactivity. The interactivity extension applies at the gITF scene level and is called MPEG_scene_interactivity. The corresponding semantics are provided in Table 1.

TABLE 1
Semantics of an example MPEG_scene_interactivity extension.

| Name | Type | Usage | Default | Description |
|---|---|---|---|---|
| triggers | Array | M | [ ] | Contains the definition of all the |
| | | | | triggers used in that scene |
| actions | Array | M | [ ] | Contains the definition of all the |
| | | | | actions used in that scene |
| behaviors | Array | M | [ ] | Contains the definition of all the |
| | | | | behaviors used in that scene. A |
| | | | | behavior may include a pair of |
| | | | | (triggers, actions), control |
| | | | | parameters of triggers and actions, |
| | | | | a priority weight and an optional |
| | | | | interrupt action |

#

In Table 1 and other semantic tables described herein, the “usage” column indicates “M” for “mandatory” features and “O” for “optional” features. However, it should be understood that such features may be “mandatory” or “optional” only according to a particular proposed syntax. A feature marked “mandatory” is not necessarily a required feature to implement the invention. For example, in some embodiments, a feature marked “mandatory” is present in order to satisfy the expectations of a particular type of parsing and rendering software; however, in other embodiments, that feature may be optional, or it may be omitted entirely, with the corresponding functionality being implemented using default values or not being implemented at all without departing from the scope of the present disclosure.

The parameters of one example of a trigger are shown in Table 2.

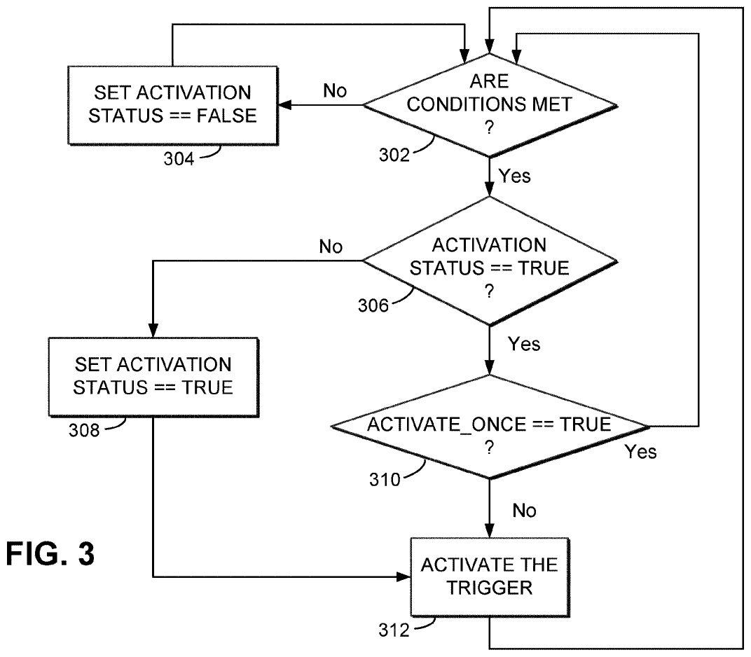

TABLE 2
Trigger semantics.

| Name | Type | Usage | Default | Description |
|---|---|---|---|---|
| type | enumeration | M | VISIBILITY | Defines the type of the trigger by |
| | | | | taking one of the following |
| | | | | values: |
| | | | | VISIBILITY = 0, |
| | | | | PROXIMITY = 1, |
| | | | | USER_INPUT = 2, |
| | | | | TIMED = 3, |
| | | | | COLLIDER = 4 |
| activateOnce | Boolean | M | FALSE | If FALSE: the trigger is activated |
| | | | | each time its conditions are met. |
| | | | | If TRUE: the trigger is activated |
| | | | | once when its conditions are met. |
| | | | | Refer to FIG. 3 |
| If(type == VISIBILITY){ | | | | |
| cameraNode | Number | M | | Index to the node containing a |
| | | | | camera in the nodes array for |
| | | | | which the visibilities are |
| | | | | determined |
| Nodes | Array | M | | Indices of the nodes in the nodes |
| | | | | array to be considered. All the |
| | | | | nodes shall be visible by the |
| | | | | camera to activate the trigger |
| } | | | | |
| If(type == PROXIMITY){ | | | | |
| distanceLowerLimit | Number | M | 0 | Threshold min in meters for the |
| | | | | node proximity calculation |
| distanceUpperLimit | Number | O | | Threshold max in meters for the |
| | | | | node proximity calculation |
| Nodes | Array | | | Indices of the nodes in the nodes |
| | | | | array to be considered. All the |
| | | | | nodes shall have a distance from |
| | | | | the user camera above the |
| | | | | distanceLowerLimit and below |
| | | | | the distanceUpperLimit to |
| | | | | activate the trigger |
| } | | | | |
| If(type == USER_INPUT){ | | | | |
| userInputDescription | String | M | | Describe the user body part and |
| | | | | gesture related to the input. E.g. |
| | | | | “/user/hand/left/grip” as specified |
| | | | | in OpenXR for the interaction |
| | | | | profile path |
| Nodes | Array | O | | Indices of the nodes in the nodes |
| | | | | array to be considered for this user |
| | | | | input |
| } | | | | |
| If(type == TIMED){ | | | | |
| Media | Number | M | 0 | Index of the media in the MPEG |
| | | | | media array used to retrieve the |
| | | | | incremented media timeline. The |
| | | | | incremented time shall be higher |
| | | | | than the timeLowerLimit and |
| | | | | below the timeUpperLimit to |
| | | | | activate the trigger |
| timeLowerLimit | Number | M | 0 | Threshold min in second |
| timeUpperLimit | Number | O | | Threshold max in second |
| } | | | | |
| If(type == COLLIDER){ | | | | |
| Nodes | Array | M | | Indices of the nodes in the nodes |
| | | | | array to be considered for |
| | | | | collision determination. Any |
| | | | | detection of collision shall |
| | | | | activate the trigger |
| } | | | | |

In some embodiments, instead of using a string parameter related to the Khronos OpenXR interaction profile paths syntax to define the user body part and gesture for the USER_INPUT trigger, other syntax formats may be used, such as a syntax format used for representation of haptic objects, where an array of vertices (geometric model) and a binary mask (body part mask) are used to specify where the haptic effect should be applied.

Example parameters of an action are shown in Table 3.

TABLE 3
Action semantics.

| Name | Type | Usage | Default | Description |
|---|---|---|---|---|
| type | enumeration | M | ACTIVATE | Defines the type of the action by |
| | | | | taking one of the following values: |
| | | | | ACTIVATE = 0, |
| | | | | TRANSFORM = 1, |
| | | | | ANIMATE = 2, |
| | | | | CONTROL_MEDIA = 3, |
| | | | | PLACE_AT = 4, |
| | | | | MANIPULATE = 5, |
| | | | | SET_MATERIAL = 6 |
| Delay | number | O | | Duration of delay in second before |
| | | | | executing the action |
| If(type == ACTIVATE){ | | | | |
| activationStatus | enum | M | ENABLED | ENABLED = 0: the node shall be |
| | | | | considered by the application |
| | | | | DISABLED = 1: the node shall not be |
| | | | | considered by the application |
| Nodes | array | M | | Indices of the nodes in the nodes |
| | | | | array to set the activation status |
| } | | | | |
| If(type == TRANSFORM){ | | | | |
| Transform | | M | | 4 × 4 transformation matrix to apply to |
| | | | | the nodes |
| Nodes | array | M | | Indices of the nodes in the nodes |
| | | | | array to be transformed |
| } | | | | |
| If(type == ANIMATE){ | | | | |
| Animation | number | M | | index of the animation in the |
| | | | | animations array to be considered |
| animationControl | enum | M | PLAY | PLAY = 0, |
| | | | | PAUSE = 1, |
| | | | | RESUME = 2, |
| | | | | STOP = 3 |
| } | | | | |
| If(type == | | | | |
| CONTROL_MEDIA){ | | | | |
| Media | number | M | | Index of the media in the MPEG |
| | | | | media array to be considered |
| mediaControl | enum | M | PLAY | PLAY = 0, |
| | | | | PAUSE = 1, |
| | | | | RESUME = 2, |
| | | | | STOP = 3 |
| } | | | | |
| If(type == PLACE_AT){ | | | | |
| placeDescription | string | M | | Describe the place position. E.g. |
| | | | | “/user/hand/left/pose” |
| Nodes | array | M | | Indices of the nodes in the nodes |
| | | | | array to be placed. |
| } | | | | |
| If(type == MANIPULATE){ | | | | |
| Action | enum | M | FREE | FREE = 0: the nodes follow the user |
| | | | | pointing device and its rotation, |
| | | | | FREE_FIXED_ROTATION = 1: the |
| | | | | nodes follow the user pointing |
| | | | | device but without rotation, |
| | | | | SLIDE = 2: the nodes move linearly |
| | | | | along the provided axis by |
| | | | | following the user pointing device |
| | | | | TRANSLATE = 3: the nodes |
| | | | | translate by following the user |
| | | | | pointing device, |
| | | | | ROTATE = 4: the nodes rotate |
| | | | | around the provided axis by |
| | | | | following the user pointing device, |
| | | | | SCALE = 5: performs a central |
| | | | | scaling of the nodes by following |
| | | | | the user pointing device |
| Axis | array | O | | (x, y, z) coordinates of the axis used |
| | | | | for rotation and sliding. These |
| | | | | coordinates are relative to the local |
| | | | | space created by the USER_INPUT |
| | | | | trigger activation. E.g. a |
| | | | | “/user/hand/left/pose” user input |
| | | | | trigger creates a local space attached |
| | | | | to the user left hand |
| Nodes | array | M | | Indices of the nodes in the nodes |
| | | | | array to be manipulated |
| } | | | | |
| If(type == SET_MATERIAL){ | | | | |
| Material | number | M | | Index of the material in the materials |
| | | | | array to apply to the nodes |
| Nodes | array | M | | Indices of the nodes in the nodes |
| | | | | array to set their material |
| } | | | | |

Example parameters of a behavior are shown in Table 4.

TABLE 4
Behavior semantics.

| Name | Type | Usage | Default | Description |
|---|---|---|---|---|
| Triggers | array | M | | Indices of the triggers in the triggers |
| | | | | array considered for this behavior |
| Actions | array | M | | Indices of the actions in the actions |
| | | | | array considered for this behavior |
| triggersControl | enum | M | LOGICAL_OR | LOGICAL_OR = 0: an activation of |
| | | | | any of the defined triggers shall |
| | | | | execute the defined actions, |
| | | | | LOGICAL_AND = 1: all the defined |
| | | | | triggers shall be activated to execute |
| | | | | the defined actions |
| actionsControl | enum | M | SEQUENTIAL | Defines the way to execute the |
| | | | | defined actions. |
| | | | | SEQUENTIAL = 0: each defined |
| | | | | action is executed sequentially in the |
| | | | | order of the actions array, |
| | | | | PARALLEL = 1: the defined actions |
| | | | | are executed concurrently |
| interruptAction | number | O | | Index of the action in the actions |
| | | | | array to be executed if the behavior |
| | | | | is still on-going and is no more |
| | | | | defined in a newly received scene |
| | | | | update |
| Priority | number | M | | Weight associated to the behavior. |
| | | | | Used to select a behavior when |
| | | | | several behaviors are active at same |
| | | | | time for one node |

#

During runtime, an application may operate by iterating on each defined behavior and checking the realization of the related triggers following the procedure illustrated in FIG. 3. FIG. 3 is a flow diagram of a processing model to activate a trigger. At 302, a determination is made of whether trigger conditions are met for the relevant trigger. If the trigger conditions are not met, then the result of that determination is then stored, e.g., an activation status variable is set to FALSE at 304. If the trigger conditions are met, then a determination is made at 306 of whether the trigger has already been activated, e.g. by checking whether the activation status has already been set to TRUE. If not then the trigger the activation status is set to TRUE at 308, and the trigger is activated at 312. If the determination at 306 indicates that the trigger has already been activated, then a determination is made at 310 of whether the relevant trigger is intended to be activated only once (as opposed, e.g. to a trigger intended to be active for as long as the trigger conditions exist). If the trigger is intended to be activated only once, and if it has already been activated (as determined at 306), then the trigger is not activated again. Otherwise, the trigger is again activated at 312.

In response to the activation of the defined triggers of a behavior, the corresponding actions are launched. A behavior has an on-going status between the launch and the completion of its defined actions.

In some embodiments, when several behaviors are in concurrence to affect the same node (or other scene element) at the same time, only the behavior having the highest priority is launched.

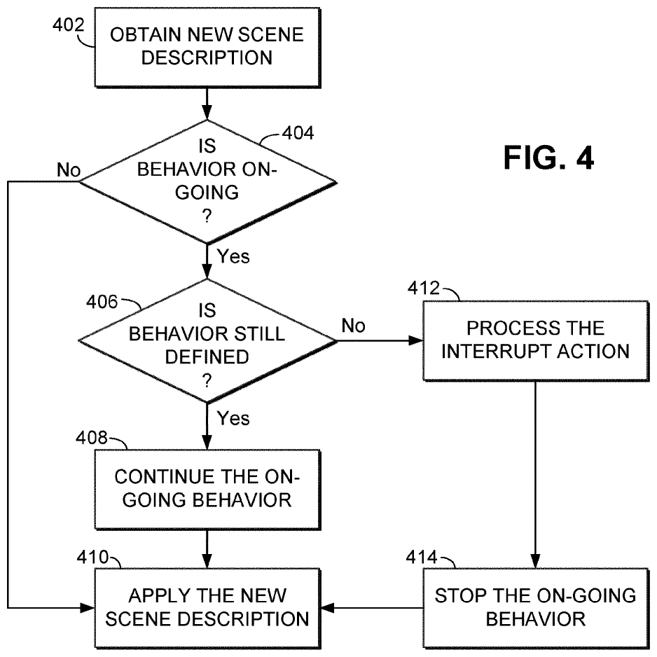

In some embodiments, in response to receipt of a new scene description, an application follows a procedure as shown in FIG. 4. FIG. 4 is a flow chart illustrating a processing model implemented in response to receipt of a new scene description. After a new scene description is obtained (402), a determination is made (404) of whether a behavior has an on-going status. In response to the behavior not having an on-going status, the new scene description is applied (410). If the behavior does have an on-going status, a determination is made (406) of whether the behavior is still defined. For instance, a behavior is no longer defined if the related object has been removed or if the behavior is no longer relevant for this current media (e.g. audio or video) sequence. If the behavior is no longer defined, then an interrupt action is processed (412) and the on-going behavior is stopped (414) before applying the new scene description (410). If it is determined at 406 that the behavior is still defined, then the on-going behavior is continued (408) as the new scene description is applied (410).

### Example Interactive Object.

As an example of an interactive virtual object according to some embodiments, a virtual 3D advertisement object may be continuously displayed and transformed during a defined period (e.g. between 20 seconds and 40 seconds) in an MPEG media sequence between. In this example, once the user's left hand is detected, the virtual 3D object is placed on the user left hand and continuously follows it.

In this example, two behaviors are defined to support this interactivity scenario. The first behavior has the following parameters:
A single trigger related to a time sequence of a MPEG media between 20 seconds and 40 seconds with a continuous activation (“activateOnce”=FALSE).
Two sequential actions to enable and transform the virtual 3D object (node 0).

The second behavior has the following parameters:
A single trigger related to the user left-hand detection with a continuous activation (“activateOnce”=FALSE).
A single action to place the virtual object (node 0) on the user's left hand.

The two behaviors define the same interrupt action which disables the virtual object (node 0).

As the two behaviors affect the same virtual object (node 0), a higher priority is set to the second behavior related to the user gesture (pose of the left hand) to perform the desired interactivity scenario. In this example, the desired behaviors may be implemented using scene interactivity information, which may be provided in a JSON format such as the following or in an alternative format.

```
{
  ″extensionsUsed″ : [
      ″ MPEG_scene_interactivity ″
  ],
  ″scene″: 0,
  ″scenes″: [
      {
        ″extensions″: {
              ″ MPEG_scene_interactivity ″: {
            “triggers:” [
                      {
                          ″type″: TIMED,
                          ″activateOnce″: FALSE,
                                              ″ media ″:3
                          ″ timeLowerLimit″ : 20
                          ″ timeUpperLimit″ : 40
                          ″ nodes″:[0]
                      },
                      {
                          ″ type″: USER_INPUT,
                          ″activateOnce″: FALSE,
″ userInputDescription″:“/user/hand/left/pose”
                      }
              ],
            “actions:” [
                  {
                          ″ type″: ACTIVATE,
                          ″ activationStatus″ : ENABLED
                          ″ nodes ″[ 0]
                  },
                  {
                        ″ type″: PLACE_AT,
                        ″ placeDescription″: “/user/hand/left/pose”
                        ″ nodes″:[0]
                  },
                  {
                          ″ type″: TRANSFORM,
                          ″ transform″ : [1,0,0,0,0,1,0,0,0,0,1,1]
                          ″ nodes ″[ 0]
                  },
                  {
                          ″ type″: ACTIVATE,
                          ″ activationStatus″: DISABLED
                          ″ nodes ″[ 0]
                  }
          ],
          “behaviors:” [
                {
                  “triggers”:[0],
                    “actions”:[0,2],
                    “triggersControl”:LOGICAL_AND
                    “actionsControl”:SEQUENTIAL,
                    “interruptAction“:3,
                    “priority”: 1
                },
                {
                  “triggers”:[1],
                    “actions”:[1],
                    “triggersControl“:LOGICAL_AND
                    “actionsControl”:SEQUENTIAL,
                    “interruptAction“:3,
                    “priority”: 2
                }
          ]
    },
            ″name″: ″Scene″,
            ″nodes″: [
                    0
            ]
  ],
  ″nodes″: [
      {
              ″name″: ″Node0″,
              ″mesh″: 0
      },
      ...
  ]
}
```

### Runtime Interactivity for Light Sources.

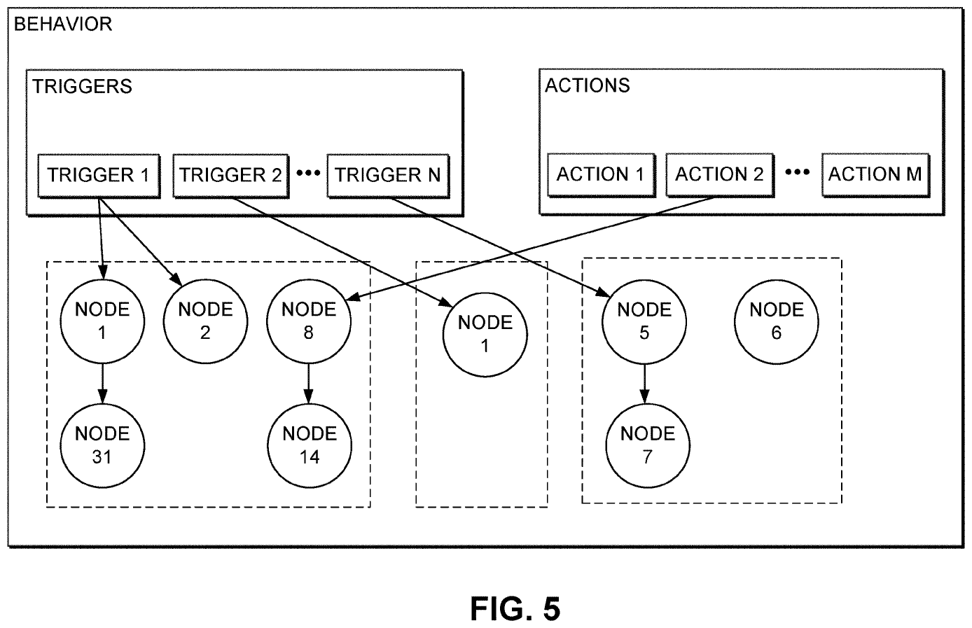

In XR applications, a scene description is used to combine explicit and easy-to-parse description of a scene structure and some binary representations of media content. The above sections describe action mechanisms for scene descriptions. These behaviors are related to pre-defined virtual objects on which runtime interactivity is allowed for user specific XR experiences. FIG. 5 illustrates the structure of an example behavior mechanism.

Some embodiments expand on the interactivity for virtual objects as described above to provide interactions of lighting, such as the intensity of light being dependent on the proximity of a user (e.g. triggered by a proximity trigger), the color of the light depending on the time of day, and other types of interactivity. Example embodiments enable specialized lighting interactions for any lights of a scene description.

In some embodiments, the Action semantic of a scene description includes a SET_LIGHT field for dedicated light actions.

In Table 5, below, the term cubemap refers to the array of image-based lights (also named IBL) described in the EXT_lights_image_based extension.

In an example embodiment, a scene description augmentation includes one or more of the following:
A parameter multiplying the current intensity level of a light node (Number).
A parameter that allows enabling and disabling shadows casting from a light (Boolean).
A parameter that allows changing the light color (Array).
A parameter that defines the distance at which the light intensity may be considered to have reached zero (Number).
A parameter that changes the width of an area light (Number).
A parameter that changes the height of an area light (Number).
A parameter that allows changing the rotation of a cubemap (Quaternion).
A parameter that sets the irradiance coefficient (Array).
A parameter to change the resolution of images that composed the cubemap (Number).
A parameter that replaces the images used for the cubemap (Array).
A parameter that indicates which light node is being referenced referencing (Array). In some embodiments, this parameter may be mandatory.

In the example of Khronos GLTF, there are two light extensions concerned: the KHR_lights_punctual extension which supports directional, point and spotlights, and EXT_lights_image_based extension which supports an array of image-based lights (in other terms, these are a cubemap that describes the specular radiance of the scene, the I=2 spherical harmonics coefficients for diffuse irradiance, rotation and intensity values).

The current implementation of KHR_lights_punctual does not support area light yet, but since this light type is efficient for integrating virtual objects in a real environment and for describing real lights, and since it exists in game engines like Unity or Unreal Engine, it is expected that the gITF format will add support for area light.

This area light may be a square quad, with the following parameters (additively to every light parameter already existing): width and height, and whether it will inherit parent transforms like other lights.

Example embodiments are described with reference to the MPEG-I Scene Description framework using the Khronos gITF extension mechanism to support additional scene description features. However, the principles described herein are not limited to any particular scene description framework.

In an example embodiment, a SET_LIGHT action is provided in addition to the actions already defined in Table 3. An example of semantics for the SET_LIGHT action at the node level is provided in Table 5. An example SET_LIGHT action indicates a modification to at least one illumination property of a virtual light source, such as an intensity, color, size, range, orientation, and/or shadowing property or the virtual light source.

TABLE 5
Semantics of an example light action.

| Name | Type | Usage | Default | Description |
|---|---|---|---|---|
| If (type == SET_LIGHT) { | | | | |
| Intensity | number | O | 1 | The light node intensity is |
| | | | | multiplied by a custom value. |
| castShadows | Boolean | O | TRUE | Define if there are shadows to be |
| | | | | casted from this light node. |
| Color | Array | O | 1.0, 1.0, 1.0 | Changes the color of the light node. |
| Range | Number | O | 1 | Defining a distance cutoff at which |
| | | | | the light intensity may be |
| | | | | considered to have reached zero. |
| innerConeAngle | Number | O | 0.0 | Define the angle (in radians) from |
| | | | | centre of spotlight where falloff |
| | | | | begins - only applies when the type |
| | | | | is spot. |
| outerConeAngle | Number | O | PI/4.0 | Define the angle (in radians) from |
| | | | | centre of spotlight where falloff |
| | | | | ends - only applies when the type |
| | | | | is spot |
| width | Number | O | 1.0 | Multiplies the width of an area light - |
| | | | | only applies when the type is area |
| | | | | light |
| height | Number | O | 1.0 | Multiplies the height of an area |
| | | | | light - only applies when the type |
| | | | | is area light |
| rotation | Quaternion | O | [0, 0, 0, 1] | Rotation of the cubemap - only |
| | | | | applies to cubemaps |
| irradianceCoefficientsMultiplier | Number | O | 1.0 | Multiply the irradianceCoefficients |
| | | | | arrays of floats (3 × 9 array of floats) |
| | | | | of the cubemap. - only applies to |
| | | | | cubemaps |
| specularImageSize | Number | O | 256 | Changes the resolution of each |
| | | | | image of the cubemap. - only |
| | | | | applies to cubemaps |
| specularImages | Array | O | Null | Defines the images that should be |
| | | | | used by the cubemap. - only |
| | | | | applies to cubemaps |
| nodes | Array | M | | Indices of the nodes in the light |
| | | | | nodes array containing the lights to |
| | | | | be manipulated. |
| } | | | | |

As an example, information indicating runtime interactivity for light sources may be expressed in a GLTF file using a JSON (JavaScript Object Notation) format such as the following. However, the principles described herein are not limited to any particular syntactical format.

```
{
  “extensionsUsed” : [
    “MPEG_scene_interactivity”,
    “KHR_lights_punctual”,
    “EXT_lights_image_based”
  ],
  “extensionsRequired” : [
    “MPEG_scene_interactivity”,
    “KHR_lights_punctual”,
    “EXT_lights_image_based”
  ],
    “extensions” : {
      “MPEG_scene_interactivity” : {
        “triggers” : [
        {
          “type” : TIMED,
          “activateOnce” : FALSE,
          “media” : 3,
          “timeLowerLimit” : 20,
          “timeUpperLimit” : 40,
          “nodes” : [0]
        },
        {
          “type” : USER_INPUT,
          “activateOnce” : FALSE,
          “userInputDescription” : “/user/hand/left/pose”
        }
        ],
        “actions” : [
        {
          “type” : ACTIVATE,
          “activationStatus” : ENABLED,
          “nodes” : [0]
        },
        {
          “type” : SET_LIGHT,
          “intensity” : 1.5,
          “castShadows” : FALSE,
          “color” : [
            0.7,
            0.66,
            0.85
          ],
          “range” : 1.3,
          “nodes” : [0]
        },
        {
          “type” : SET_LIGHT,
          “intensity” : 1.1,
          “irradianceCoefficientsMultiplier” : 1.2,
          “specularImageSize” : 1024,
          “nodes” : [0]
        },
        {
          “type” : TRANSFORM,
          “transform” : [1,0,0,0,0,1,0,0,0,0,1,1],
          “nodes” : [0]
        }
        ],
        “behaviors” : [
        {
          “triggers” : [0],
          “actions” : [0,2],
          “triggersControl” : LOGICAL_AND,
          “actionsControl” : SEQUENTIAL,
          “interruptAction” : 3,
          “priority” : 1
        },
        {
          “triggers” : [1],
          “actions” : [1],
          “triggersControl” : LOGICAL_AND,
          “actionsControl” : SEQUENTIAL,
          “interruptAction” : 3,
          “priority” : 2
        }
        ]
      },
      “KHR_lights_punctual” : {
        “lights” : [
          {
            “color” : [
              1.0,
              1.0,
              1.0
            ],
            “intensity” : 1000,
            “type” : “point”,
            “name” : “pointLight”
          }
        ]
      },
      “EXT_lights_image_based” : {
        “lights” : [
          {
            “name” : “cubemap”,
            “intensity” : 1.0,
            “rotation” : [0.0,0,0,1],
            “irradianceCoefficients” : [
              ...3 × 9 array of floats...
            ],
            “specularImageSize” : 256,
            “specularImages” : [
              [... 6 cube faces for mip 0 ...],
              ...
              [... 6 cube faces for mip n ...]
            ]
          }
        ]
      }
    },
    “scene” : 0,
    “scenes” : [
      {
        “extensions” : {
          “EXT_lights_image_based” : {
            “light” : 0
          }
        },
        “name” : “Scene”,
        “nodes” : [
          0,
          1,
          2
        ]
      }
    ],
  “nodes” : [
    {
      “extensions” : {
        “KHR_lights_punctual” : {
          “light” : 0
        }
      },
      “name” : “Light_Orientation”,
      “rotation” : [
        ...
      ]
      ...
    },
    ...
  ]
}
```

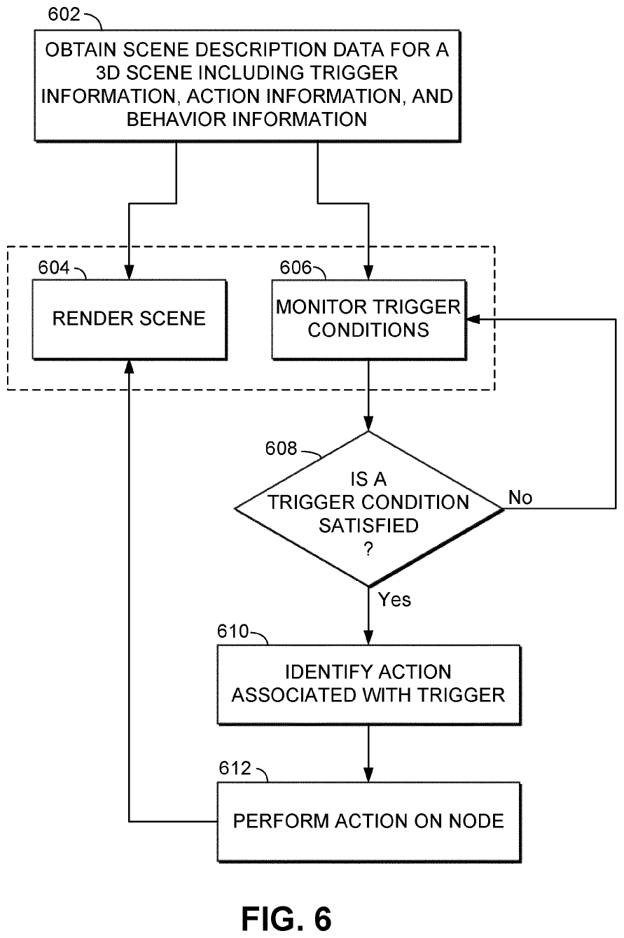

FIG. 6 is a flow chart illustrating a method performed according to some embodiments, scene description data is obtained for a 3D scene. The scene description data may be in GLTF format or in another format. The scene description data may include: scene element information describing each of a plurality of scene elements in the scene, trigger information describing at least one trigger condition, action information describing at least one action to perform on one or more scene elements associated with the action, and behavior information, wherein the behavior information associates at least one of the trigger conditions with at least one of the actions. In some embodiments, the action is performed on a scene element that is associated with a corresponding node in a hierarchical scene description graph. Alternatively or additionally, one or more of the actions may be performed on a scene element that is not associated with a particular node, such as an animation or MPEG_media element contained in the scene description.

In an example method as illustrated in FIG. 6, scene description data is obtained (602) for a 3D scene. The scene description data includes scene element information describing each of a plurality of scene elements in the scene, where at least one of the scene elements is a virtual light source. The scene description data further includes trigger information describing at least a first trigger condition. The scene description data further includes action information that describes at least a first action and that associates one or more of the scene elements, including the virtual light source, with at least the first action. The scene description data further includes behavior information. The behavior information associates at least the first trigger condition with at least the first action. The behavior information may also identify additional behaviors that associate other trigger conditions with other actions. At 604, the scene is rendered based on the scene description data. At 606, which may be performed during rendering of the scene, the scene (and/or a user's interactions with the scene) is monitored for trigger conditions, including being monitored for at least the first trigger condition. At 608, a determination is made of whether a trigger condition is satisfied. If a trigger condition is satisfied, then at 610, one or more actions associated with that trigger is identified. This identification may be made based on the behavior information, which associates trigger conditions with corresponding actions. At 612, the identified action is performed on the node (or other scene element) identified in the action. For example, where the action is associated with a virtual light source, the action is performed on the virtual light source. The rendering of the scene 604 may continue, with the appearance or other feature of the scene being updated according to the action or actions performed (e.g. with the properties of one or more virtual light sources having been changed based on the action).

In some embodiments, characteristics of user interactivity are monitored to detect whether a trigger condition is satisfied. Monitored characteristics may include, for example, position of the user camera or viewpoint (as determined through user input and/or through sensors such as gyroscopes and accelerometers, among other possibilities), user gestures (as detected through cameras, wrist-mounted or hand-held accelerometers, or other sensors), or other user input.

In response to a determination that at least one of the trigger conditions has been met and that at least a first one of the actions is associated with the trigger conditions by the behavior information, the first action is performed on at least a first scene element associated with the first action. In some embodiments, at least one of the scene elements is a virtual light source and at least one of the actions is an action performed on the virtual light source.

In some embodiments, the action results in a modification to one or more scene elements in the scene description of the 3D scene. The method in some embodiments includes rendering the 3D scene according to the changed scene description. In other embodiments, a modified scene description is provided to a separate renderer for rendering the 3D scene according to conventional 3D rendering techniques. The 3D scene may be displayed on any display device, such as the display devices described herein or others. In some embodiments, the 3D scene may be displayed as an overlay together with a real-world scene using optical see-through or video see-through display. It should be noted that the display of a 3D scene as referred to herein includes displaying a 2D projection of the 3D scene using a 2D display device.

### FURTHER EMBODIMENTS

This disclosure describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the disclosure or scope of those aspects. Indeed, all of the different aspects can be combined and interchanged to provide further aspects. Moreover, the aspects can be combined and interchanged with aspects described in earlier filings as well.

The aspects described and contemplated in this disclosure can be implemented in many different forms. While some embodiments are illustrated specifically, other embodiments are contemplated, and the discussion of particular embodiments does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

Various numeric values may be used in the present disclosure, for example. The specific values are for example purposes and the aspects described are not limited to these specific values.

Embodiments described herein may be carried out by computer software implemented by a processor or other hardware, or by a combination of hardware and software. As a non-limiting example, the embodiments can be implemented by one or more integrated circuits. The processor can be of any type appropriate to the technical environment and can encompass one or more of microprocessors, general purpose computers, special purpose computers, and processors based on a multi-core architecture, as non-limiting examples.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this disclosure are not necessarily all referring to the same embodiment.

Additionally, this disclosure may refer to “determining” various pieces of information. Determining the information can include one or more of, for example, estimating the information, calculating the information, predicting the information, or retrieving the information from memory.

Further, this disclosure may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this disclosure may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items as are listed.

Also, as used herein, the word “signal” refers to, among other things, indicating something to a corresponding decoder. For example, in certain embodiments the encoder signals a particular one of a plurality of parameters for region-based filter parameter selection for de-artifact filtering. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

Implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

We describe a number of embodiments. Features of these embodiments can be provided alone or in any combination, across various claim categories and types. Further, embodiments can include one or more of the following features, devices, or aspects, alone or in any combination, across various claim categories and types:
A bitstream or signal that includes one or more of the described syntax elements, or variations thereof.
A bitstream or signal that includes syntax conveying information generated according to any of the embodiments described.
Creating and/or transmitting and/or receiving and/or decoding a bitstream or signal that includes one or more of the described syntax elements, or variations thereof.
Creating and/or transmitting and/or receiving and/or decoding according to any of the embodiments described.
A method, process, apparatus, medium storing instructions, medium storing data, or signal according to any of the embodiments described.

Note that various hardware elements of one or more of the described embodiments are referred to as “modules” that carry out (i.e., perform, execute, and the like) various functions that are described herein in connection with the respective modules. As used herein, a module includes hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable for a given implementation. Each described module may also include instructions executable for carrying out the one or more functions described as being carried out by the respective module, and it is noted that those instructions could take the form of or include hardware (i.e., hardwired) instructions, firmware instructions, software instructions, and/or the like, and may be stored in any suitable non-transitory computer-readable medium or media, such as commonly referred to as RAM, ROM, etc.

Although features and elements are described above in particular combinations, each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method comprising:
obtaining scene description data for a 3D scene, wherein the scene description data includes:
scene element information describing each of a plurality of scene elements in the scene, at least one of the scene elements being a virtual light source;
trigger information describing at least a first trigger condition;
action information describing at least a first action, the first action indicating a modification to at least one property of the virtual light source; and
behavior information, wherein the behavior information associates at least the first trigger condition with at least the first action; and
in response to a determination that at least the first trigger condition has been met, performing at least the first action on at least the virtual light source.

2. The method of claim 1, wherein the first action comprises multiplying an intensity of the virtual light source by a specified value.

3. The method of claim 1, wherein the first action comprises setting a value indicating whether or not shadows are cast by the virtual light source.

4. The method of claim 1, wherein the first action comprises changing a color of the virtual light source.

5. The method of claim 1, wherein the first action comprises setting a distance cutoff for the virtual light source.

6. The method of claim 1, wherein the virtual light source is a virtual spot light source, and the first action comprises defining an inner cone angle where intensity falloff begins for the virtual spot light source.

7. (canceled)

8. The method of claim 1, wherein the virtual light source is a virtual area light source and the first action comprises changing a width or a height of the virtual area light source.

9. The method of claim 1, wherein the virtual light source is a virtual cubemap light source and the first action comprises applying a specified rotation to the virtual cubemap light source.

10-11. (canceled)

12. The method of claim 1, wherein the virtual light source is a virtual cubemap light source and the first action comprises defining images to be used by the virtual cubemap light source.

13. The method of claim 1, wherein the first trigger condition is a visibility condition that is satisfied when a specified scene element is visible to a specified camera node.

14-16. (canceled)

17. The method of claim 1, wherein the first trigger condition is a collider condition that is satisfied in response to detection of a collision between specified scene elements.

18. The method of claim 1, wherein the behavior information associates the first action with a plurality of trigger conditions, and wherein the behavior information further includes information indicating whether the first associated action is to be performed (i) in response to a determination that all of the plurality of trigger conditions have been met, or (ii) in response to a determination that any one of the plurality of trigger conditions has been met.

19-25. (canceled)

26. The method of claim 1, wherein each action described in the action information includes action type information, and wherein the action type information for at least the first action comprises information indicating a dedicated light action.

27. The method of claim 1, further comprising rendering the 3D scene, wherein the determination that the first trigger condition has been met is made during rendering of the 3D scene.

28-33. (canceled)

34. An apparatus comprising one or more processors configured to perform at least:
obtaining scene description data for a 3D scene, wherein the scene description data includes:
scene element information describing each of a plurality of scene elements in the scene, at least one of the scene elements being a virtual light source;
trigger information describing at least a first trigger condition;
action information describing at least a first action, the first action indicating a modification to at least one property of the virtual light source; and
behavior information, wherein the behavior information associates at least the first trigger condition with at least the first action; and
in response to a determination that at least the first trigger condition has been met, performing at least the first action on at least the virtual light source.

35. The apparatus of claim 34, wherein the first action comprises multiplying an intensity of the virtual light source by a specified value.

36. The apparatus of claim 34, wherein the first action comprises setting a value indicating whether or not shadows are cast by the virtual light source.

37. The apparatus method of claim 34, wherein the first action comprises changing a color of the virtual light source.

38. The apparatus of claim 34, wherein the virtual light source is a virtual spot light source, and the first action comprises defining an inner cone angle where intensity falloff begins for the virtual spot light source.

39. The apparatus method of claim 34, wherein the virtual light source is a virtual cubemap light source and the first action comprises defining images to be used by the virtual cubemap light source.
